(19) United States
(12) Patent Application Publication
(10) Pub. No.: US 2019/0039589 A1
(43) Pub. Date: Feb. 7, 2019

(54) AIR SUPPLY SYSTEM

(71) Applicant: KNORR-BREMSE SYSTEME FÜR SCHIENENFAHRZEUGE GMBH, Munich (DE)

(72) Inventors: Christian BECKER, Munich (DE); Gerhard PRÖLL, Garching (DE); Adrian PLATAS DEL COSO, Munich (DE)

(73) Assignee: KNORR-BREMSE SYSTEME FÜR SCHIENENFAHRZEUGE GMBH, Munich (DE)

(21) Appl. No.: 16/071,015

(22) PCT Filed: Jan. 13, 2017
(86) PCT No.: PCT/EP2017/050664

§ 371 Date: Jul. 18, 2018

(30) Foreign Application Priority Data
Jan. 18, 2016 (DE) 10 2016 100 705.6

(51) Int. Cl. B60T 17/00; B60T 17/02; F04B 49/08; F15B 21/04; F04C 29/04; F04D 29/66; F04C 18/16; B01D 53/26; B61D 27/00

(52) U.S. Cl. CPC B60T 17/004; B60T 17/02; F04B 49/08; F15B 21/048; F04C 29/04; B01D 2258/06; F04C 18/16; B01D 53/261; B61D 27/00; F25B 2500/12; B01D 2257/80; F04D 29/663

(57) ABSTRACT

An air supply system to be mounted in or on a railway vehicle or commercial vehicle comprises a compressor device for producing compressed air, an air dryer device for dehumidifying the compressed air, and a housing for enclosing the compressor device and the air dryer device. Furthermore, a cooling is provided which can be operated independently of the operating mode of the compressor device.

### CROSS REFERENCE AND PRIORITY

This patent application is a U.S. National Phase of International Patent Application No. PCT/EP2017/050664, filed Jan. 13, 2017, which claims priority to German Patent Application No. 10 2016 100 705.6 filed Jan. 18, 2016, the disclosure of which being incorporated herein by reference in their entireties.

### FIELD

Disclosed embodiments relate to an air supply system, in particular an air supply system for mounting in or on a rail vehicle or a commercial vehicle.

### BACKGROUND

Presently disclosed embodiments extend mainly to rail vehicles, of which the compressed-air-supply system serves predominantly in order to supply a braking pressure for the vehicle brakes. However, it is possible for the air supply system of the disclosed embodiments to be used in basically for all kinds of commercial vehicle, in order to support corresponding compressed-air systems therein.

### SUMMARY

Disclosed embodiments create an improved air supply system with a cooling system.

The disclosed air supply system has a compressor device for generating compressed air, an air-drier device for dehumidifying the compressed air, and a housing for enclosing the compressor device and the air-drier device. The disclosed embodiments additionally provide a cooling device, which can be operated irrespective of the operating state of the compressor device.

### BRIEF DESCRIPTION OF FIGURES

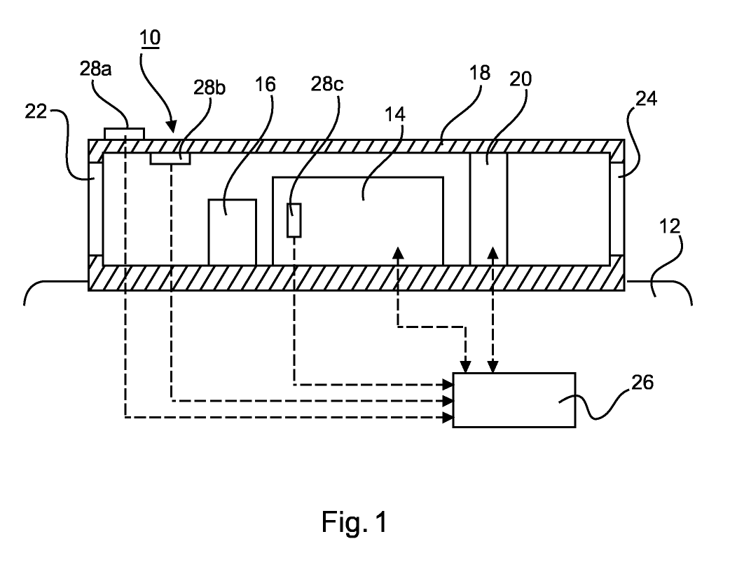

Features and advantages of the disclosed embodiments better understood from the following description of an exemplary embodiment with reference to the accompanying drawing, in which FIG. 1, the only FIGURE, shows, in a highly simplified manner, the construction of an air supply system according to an exemplary embodiment.

### DETAILED DESCRIPTION

Noise-control requirements are increasing in respect of rail vehicles, in particular rail vehicles which travel in residential areas. This necessitates ever-increasing outlay for the sound optimization of such air supply systems, wherein particularly stringent requirements in respect of the maximum permissible level of sound radiation prevail in the passenger-transport sector. Air supply systems which are mounted on the roof or under the floor of a rail vehicle therefore often have a housing for enclosing their components, the housing being, as far as possible, sound-optimized. DE 10 2012 007 027 A1 discloses, for example, a sound-optimized intake box for an enclosed air supply system. DE 101 21 582 A1 describes an air supply system having a silencer for damping the air-venting noise.

In particular in the case of soundproofed/enclosed air supply systems which are mounted on the roof or under the floor, it is necessary to have a cooling system, which can prevent thermal overheating of the air supply system.

Disclosed embodiments create an improved air supply system with a cooling system. The disclosed air supply system has a compressor device for generating compressed air, an air-drier device for dehumidifying the compressed air, and a housing for enclosing the compressor device and the air-drier device. The disclosed embodiments additionally provide a cooling device, which can be operated irrespective of the operating state of the compressor device.

The cooling device, which can be operated irrespective of the operating state of the compressor device, makes it possible to reduce the risk of the air supply system overheating in any operating state. The cooling device here can be operated in particular also when the compressor device is switched off.

In an advantageous configuration of the disclosed embodiments, a control device is provided for activating the cooling device. The cooling device, then, can be activated by the control device irrespective of the operating state of the compressor device. The control device is configured to activate the cooling device; the control device can optionally also activate other components of the air supply system or the air supply system as a whole.

In an advantageous configuration of the disclosed embodiments, the cooling device has a fan device for generating a cooling-air stream through the housing. The fan device optionally has at least one fan. The fan can be configured, for example, in the form of a radial fan or axial fan, but it is possible for the cooling-air stream to be generated, in principle, by fans of any desired design.

In this configuration, the housing optionally has at least one cooling-air entry and at least one cooling-air exit, and the fan device of the cooling device is arranged in or on the housing optionally such that it can generate a cooling-air stream from the at least one cooling-air entry, through the housing, to the at least one cooling-air exit.

In a further advantageous configuration of the disclosed embodiments, it is also the case that at least one temperature sensor is provided for sensing at least one temperature value of the air supply system. The cooling device, then, can be operated optionally in dependence on the at least one temperature value sensed. The at least one temperature sensor is optionally configured to sense an ambient temperature outside the housing of the air supply system, a temperature within the housing of the air supply system, a temperature of a cooling-air stream through the housing of the air supply system, a temperature of the compressed air generated by the air supply system, a temperature of a temperature-critical component of the air supply system, or the like. The at least one temperature sensor can also comprise at least two temperature sensors in order to sense temperatures at two different locations where temperatures are to be defined (e.g. within the housing).

It is possible for the air-drier device to be arranged downstream of the compressor device, in order to dehumidify the compressed air generated by the compressor device, and/or upstream of the compressor device, in order to dehumidify the air which is to be compressed by the compressor device.

The compressor device may have a single-stage or two-stage, oil-free or oil-lubricated piston compressor or screw compressor, although in principle any design of compressor can be used for the air supply system according to the disclosed embodiments.

The housing of the air supply system can be provided with sound-damping measures. It is thus possible for the housing to have, for example, an air-venting silencer, sound-optimized air-intake boxes, sound-optimized air-channeling devices, sound-insulated housing walls and the like.

The air supply system of the disclosed embodiments is advantageously suitable for mounting on a rail vehicle or commercial vehicle, i.e. in particular on a roof or under the floor of a rail vehicle or commercial vehicle, but it can likewise be used in the interior of a vehicle.

FIG. 1 shows an air supply system 10 which can be mounted on the roof 12 of a commercial vehicle or rail vehicle. The air supply system 10 serves, for example, for supplying pneumatic devices (e.g. brakes, air springs, etc.) of a compressed-air system of the commercial vehicle or rail vehicle with compressed air.

The air supply system 10 has a compressor device 14 for generating compressed air from the ambient air, the compressor device having, for example, a single-stage or two-stage, oil-free piston compressor and a motor for driving the piston compressor. An air-drier device 16 for dehumidifying the compressed air generated is arranged downstream of the compressor device 14.

The compressor device 14 and air-drier device 16 are enclosed in a housing 18. The housing 18 is optimized in terms of flow and is optionally also optimized in terms of sound and, for this purpose, has, for example, an air-venting silencer, a sound-optimized air-intake box, a sound-optimized air-channeling device, an at least to some extent sound-insulated housing wall, etc.

The housing 18 additionally accommodates a cooling device 20, which has, for example, a fan device with at least one fan (e.g. radial fan or axial fan). The housing 18 is also provided with at least one cooling-air entry 22 and at least one cooling-air exit 24. The fan device of the cooling device 20 is configured to generate a cooling-air stream from the at least one cooling-air entry 22, through the housing 18, to the at least one cooling-air exit 24. The cooling-air stream here flows, in an optimized, forced manner, past the temperature-critical component of the air supply system 10, i.e. in particular past the compressor device 14, and cools the same.

The air supply system 10 also has a control device 26. This control device 26 controls/regulates the operation of the components of the air supply system 10, in particular of the compressor device 14. Moreover, the control device 26 activates the cooling device 20. The control device 26 is, for example, likewise arranged within the housing 18, but can also be accommodated in the rail vehicle or commercial vehicle.

Although not illustrated, the air supply system 10 can have further application-specific pneumatic components and/or electropneumatic components, for example safety valves, pressure switches, etc.

All the components of the air supply system 10 are installed in the interior of the housing 18 such that there is no thermal short circuit. For example, spacings, cooling-air baffles, heat-insulation means and/or other measures are provided to a sufficient extent between the components.

The cooling device 20 is activated here irrespective of the operating state of the air supply system 10, in particular of the compressor device 14. In particular, it is possible for the cooling device 20 to be operated not just during operation of the air supply system 10, but also while a compressor device 14 is switched off, so that the components of the air supply system 10 have air admitted to them and/or are cooled. The cooling device 20 is operated here, in particular, in a temperature-controlled manner. The activation of the cooling device 20 here covers in particular the operations of switching the cooling device 20 on and off, but optionally also power consumption and/or cooling performance of the cooling device 20.

For this purpose, the air supply system 10 has at least one temperature sensor. The at least one temperature sensor is optionally configured to sense at least one temperature within the housing 18. For example, the air supply system 10 has a temperature sensor 28a for sensing an ambient temperature outside the housing 18, or a temperature of the ambient air flowing past the air supply system, a temperature sensor 28b for sensing a temperature of the cooling-air stream through the housing 18, the cooling-air stream being generated by the fan device of the cooling device 20, a temperature sensor 28c for sensing a temperature of the compressor device 14, a temperature sensor for sensing a temperature of the compressed air generated by the compressor device 14, or the like. The temperature sensors 28a, 28b, 28c are connected to the control device 26.

It is thus possible for the air supply system 10 and in particular the temperature-critical components thereof to have air admitted to it/them and/or to be cooled with the aid of the independently activated cooling device 20 even when the air supply system 10 is not in operation. This makes it possible to prevent the situation where the air supply system 10, or the components thereof, on the roof 12/under the floor of the rail vehicle or commercial vehicle overheat(s), for example, on account of high ambient temperatures or strong sunlight.

### LIST OF REFERENCE SIGNS

10 Air supply system
12 Vehicle or vehicle roof
14 Compressor device
16 Air-drier device
18 Housing
20 Cooling device
22 Cooling-air entry
24 Cooling-air exit
26 Control device
28a Temperature sensor
28b Temperature sensor
28c Temperature sensor

1. An air supply system for a rail vehicle or commercial vehicle, the air supply system comprising having:
a compressor device for generating compressed air;
an air-drier device for dehumidifying the compressed air;
a housing for enclosing the compressor device and the air-drier device; and
a cooling device operable irrespective of the operating state of the compressor device.

2. The air supply system of claim 1, further comprising a control device for activating the cooling device, wherein the cooling device is activated irrespective of the operating state of the compressor device.

3. The air supply system of claim 1, wherein the cooling device has a fan device for generating a cooling-air stream through the housing.

4. The air supply system of claim 3, wherein the housing has at least one cooling-air entry and at least one cooling-air exit, and the fan device of the cooling device is arranged in or on the housing such that it can generate a cooling-air stream from the at least one cooling-air entry, through the housing, to the at least one cooling-air exit.

5. The air supply system of claim 1, further comprising at least one temperature sensor for sensing at least one temperature value of the air supply system, wherein the cooling device is operable in dependence on the at least one temperature value sensed.
